(19) United States
(12) Patent Application Publication
(10) Pub. No.: US 2010/0034061 A1
(43) Pub. Date: Feb. 11, 2010

(54) OPTICAL STORAGE APPARATUS AND CONTROL CHIP FOR ACCESSING AN OPTICAL DISC AND METHOD THEREOF

(76) Inventors: CHIH-CHING YU, Hsinchu City (TW); Chao-Ming Huang, Taipei Hsien (TW); Yu-Chen Kuei, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/189,201

(22) Filed: Aug. 11, 2008

(51) Int. Cl. G11B 7/00

(52) U.S. Cl. 369/44.32; G9B/7

(57) ABSTRACT

An optical storage apparatus includes an optical pickup head, a drive module, a spherical aberration compensator, and a controller module. The drive module is coupled to the optical pickup head for performing a predetermined operation associated with the optical pickup head. The spherical aberration compensator is coupled to the optical pickup head for performing a spherical aberration compensation upon the optical pickup head. The controller module is coupled to the drive module and the spherical aberration compensator for controlling the drive module to perform the predetermined operation during a first period of time and the spherical aberration compensator to perform the spherical aberration compensation during a second period of time. The first period of time overlaps the second period of time.

### BACKGROUND

The present disclosure relates to an optical storage apparatus for accessing an optical disc and a method thereof, and more particularly, to an optical storage apparatus and related method for performing a predetermined operation in conjunction with a spherical aberration compensation during a period of overlapped time.

High-density optical discs, such as Blue-ray discs (BD), include a higher NA (numerical aperture) and a thinner cover layer, thus the spherical aberration (SA hereinafter) becomes more and more serious. Because moving a spherical aberration compensator usually wastes a lot of time, the total time for accessing the optical disc will be prolonged. Therefore, a proper spherical aberration compensation is needed to improve the performance for accessing the optical disc.

Please refer to FIG. 1 and FIG. 2. FIG. 1 and FIG. 2 are each a diagram showing waveforms of related signals for accessing an optical disc according to the related art. As shown in FIG. 1 and FIG. 2, ‘Ch1’ indicates a focus error (FE) signal, ‘Ch2’ indicates a signal for moving a spherical aberration compensator (SAC), ‘Ch3’ indicates a tracking error (TE) signal, and ‘Ch4’ indicates a signal for seeking a target track. A focus jump (layer jump) and a track jump (track seek) are included during accessing the optical disc. When performing the focus jump, a spherical aberration compensation is necessary. Therefore, a time period Tₛₑₑₖ is taken to seek the target track and another time period T_{SA} is taken to move a spherical aberration compensator. In FIG. 1, seeking the target track is performed, and then the spherical aberration compensation and the focus jump are performed during accessing the optical disc. On the other hand, in FIG. 2, the spherical aberration compensation and the focus jump are performed, and then seeking the target track is performed. Therefore, a total time period Tₜₒₜₐₗ for accessing the optical disc can be represented by the following equation: Tₜₒₜₐₗ=T_{SA}+Tₛₑₑₖ+T_{LJ}, whereof the time period T_{LJ} is used for performing the focus jump and can be ignored due to its value being very small.

The time T_{SA} for moving the spherical aberration compensator usually wastes a lot of time, which prolongs the total time period Tₜₒₜₐₗ for accessing the optical disc and thereby affects the seek performance of the whole optical storage system. Besides, the spherical aberration compensation and a compensation for moving a sled are needed when powering on an optical storage apparatus, which also wastes a lot of time and affects the seek performance of the whole optical storage system. Therefore, how to improve the performance of the optical storage apparatus has becomes an important topic in this field.

### SUMMARY OF THE DISCLOSURE

It is one of the objectives of the claimed disclosure to provide an optical storage apparatus for accessing an optical disc and thereby save time for accessing the optical disc.

According to an embodiment of the present disclosure, an optical storage apparatus for accessing an optical disc is disclosed. The optical storage apparatus includes an optical pickup head, a drive module, a spherical aberration compensator, and a controller module. The optical pickup head is used for generating a light spot onto the optical disc. The drive module is coupled to the optical pickup head for performing a predetermined operation associated with the optical pickup head. The spherical aberration compensator is coupled to the optical pickup head for performing a spherical aberration compensation upon the optical pickup head. The controller module is coupled to the drive module and the spherical aberration compensator for controlling the drive module to perform the predetermined operation during a first period of time and the spherical aberration compensator to perform the spherical aberration compensation during a second period of time, wherein the first period of time overlaps the second period of time.

In one embodiment, the drive module includes a moving mechanism, and the controller module controls the moving mechanism to perform the predetermined operation for seeking a target track on the optical disc.

In one embodiment, the drive module includes a moving mechanism, and the controller module controls the moving mechanism to perform the predetermined operation for seeking a target track on the optical disc.

In one embodiment, the drive module includes a tilt compensator, and the controller module controls the tilt compensator to perform the predetermined operation for calibrating a tilt angle between the optical pickup head and the optical disc.

According to an embodiment of the present disclosure, a control chip for controlling an optical pickup head to access an optical disc is disclosed. The control chip includes a drive module, a spherical aberration compensator, and a controller module. The drive module is used for performing a predetermined operation associated with the optical pickup head. The spherical aberration compensator is used for performing a spherical aberration compensation upon the optical pickup head. The controller module is coupled to the drive module and the spherical aberration compensator for controlling the drive module to perform the predetermined operation during a first period of time and the spherical aberration compensator to perform the spherical aberration compensation during a second period of time, wherein the first period of time overlaps the second period of time.

In one embodiment, the drive module includes a moving mechanism.

In one embodiment, the drive module includes a moving mechanism.

In one embodiment, the drive module includes a tilt compensator.

According to an embodiment of the present disclosure, an optical storage apparatus for accessing an optical disc is disclosed. The optical storage apparatus includes an optical pickup head, a drive module, a compensator, and a controller module. The optical pickup head is used for generating a light spot onto the optical disc. The drive module is coupled to the optical pickup head for performing a predetermined operation associated with the optical pickup head. The compensator is coupled to the optical pickup head for performing a compensation upon an optical characteristic of the optical pickup head. The controller module is coupled to the drive module and the compensator for controlling the drive module to perform the predetermined operation during a first period of time and the compensator to perform the compensation upon an optical characteristic of the optical pickup head during a second period of time, wherein the first period of time overlaps the second period of time.

According to an embodiment of the present disclosure, a method of driving an optical pickup head utilized for accessing an optical disc is disclosed. The method includes performing a predetermined operation upon an optical pickup head during a first period of time, and performing a spherical aberration compensation upon the optical pickup head during a second period of time, wherein the first period of time overlaps the second period of time.

In one embodiment, the predetermined operation is to seek a target track on the optical disc.

In one embodiment, the predetermined operation is to move a sled on which the optical pickup head is disposed.

In one embodiment, the predetermined operation is to calibrate a tilt angle between the optical pickup head and the optical disc.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing waveforms of related signals for accessing an optical disc according to the related art.

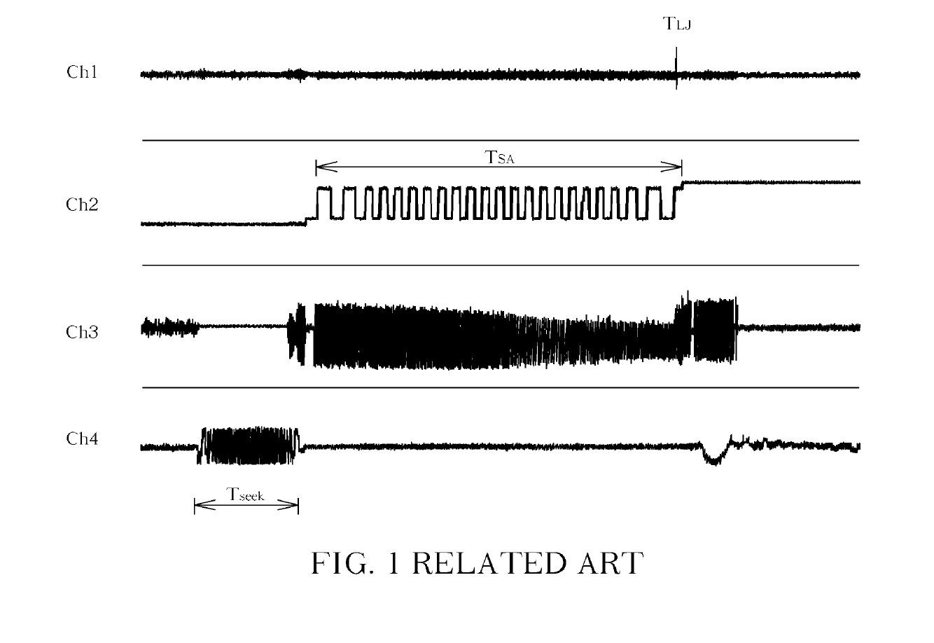

FIG. 2 is a diagram showing waveforms of related signals for accessing an optical disc according to the related art.

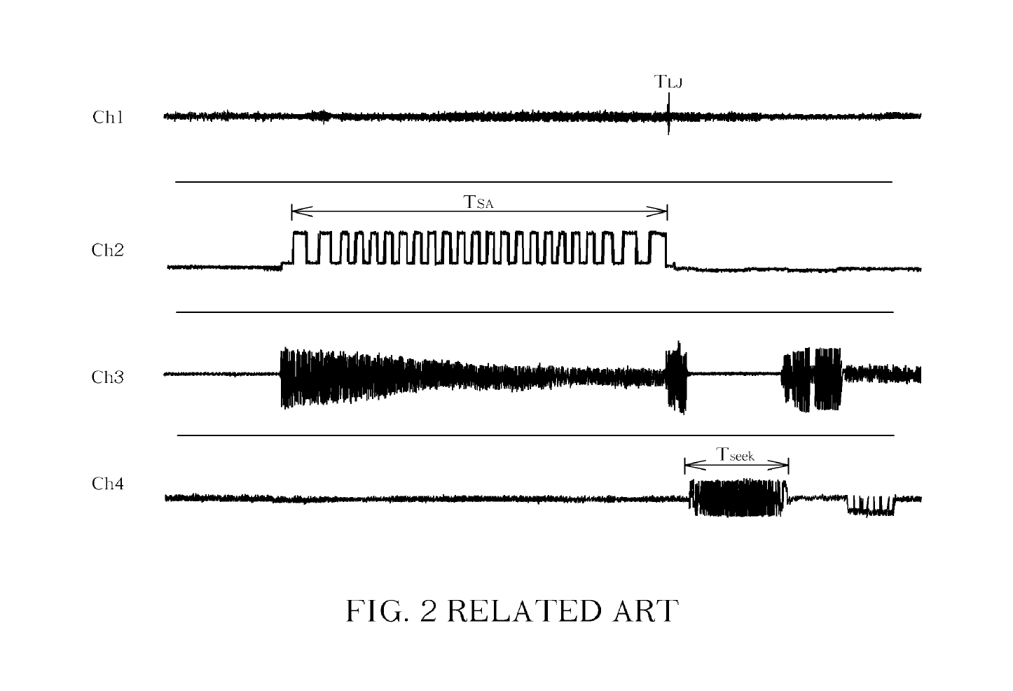

FIG. 3 is a flowchart illustrating a method of driving an optical pickup head utilized for accessing an optical disc according to an embodiment of the present disclosure.

FIG. 4 is a diagram of an optical storage apparatus for accessing an optical disc according to an embodiment of the present disclosure.

FIG. 5 is a diagram showing waveforms of related signals for accessing an optical disc according to an embodiment of the present disclosure.

FIG. 6 is a diagram of an exemplary embodiment of the total time with optimum performance.

FIG. 7 is a diagram showing waveforms of related signals for accessing an optical disc according to another embodiment of the present disclosure.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

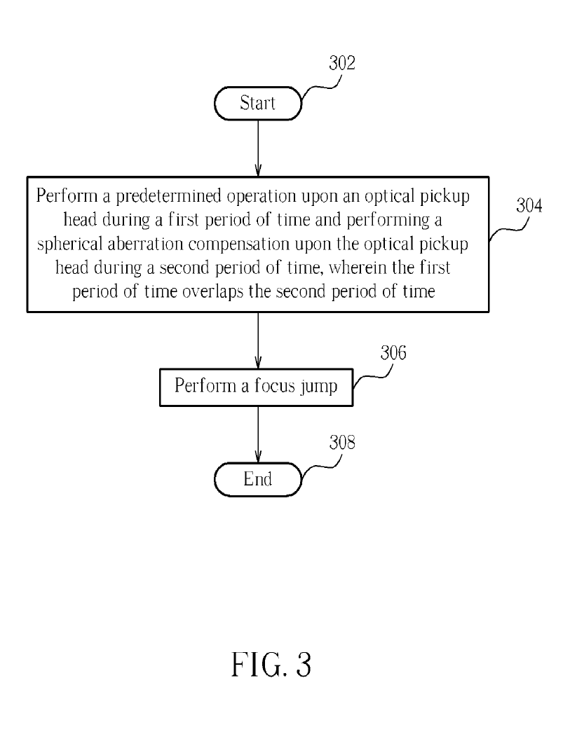

Please refer to FIG. 3. FIG. 3 is a flowchart illustrating a method of driving an optical pickup head utilized for accessing an optical disc according to an embodiment of the present disclosure. Please note that the following steps are not limited to be performed according to the exact order shown in FIG. 3 as long as a substantially identical result can be obtained. The exemplary method of the present disclosure includes the following steps:
Step 302: Start.
Step 304: Perform a predetermined operation upon an optical pickup head during a first period of time and performing a spherical aberration compensation upon the optical pickup head during a second period of time, wherein the first period of time overlaps the second period of time.
Step 306: Perform a focus jump.
Step 308: End.

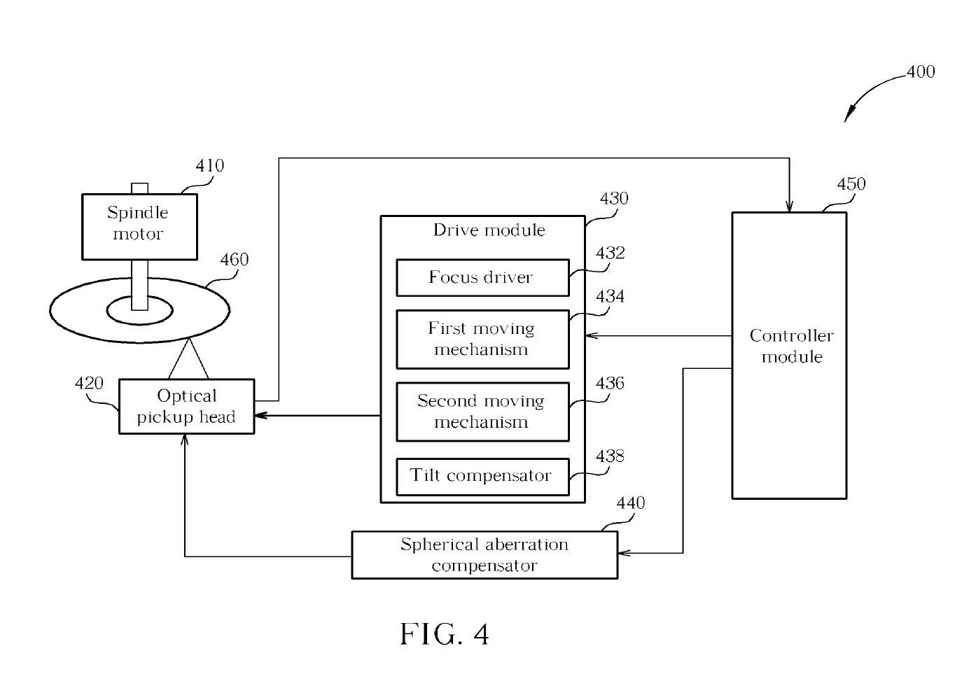

Please refer to FIG. 4. FIG. 4 is a diagram of an optical storage apparatus 400 for accessing an optical disc according to an embodiment of the present disclosure. The optical storage apparatus 400 includes, but is not limited to, a spindle motor 410, an optical pickup head 420, a drive module 430, a spherical aberration compensator 440, and a controller module 450. The spindle motor 410 is used for rotating an optical disc 460 along an axial axis at desired rotational speed. In this embodiment, the optical disc 460 can be a blue-ray disc (BD), a digital versatile disc (DVD), or a high definition DVD (HD DVD), but is not limited to this, and can be a disc of other types. The optical pickup head 420 is used for generating a light spot onto the optical disc 460 to access data. In one embodiment, the optical pickup head 420 may have components such as at least a light source (e.g., a laser diode), a lens module, a focus actuator, and a tracking actuator, etc. However, as the operations of the components of the optical pickup head 420 are not the emphasis of the present disclosure and are well known to those skilled in this art, further description is omitted here for the sake of brevity.

Please keep referring to FIG. 4. The drive module 430 is coupled to the optical pickup head 420 for performing a predetermined operation associated with the optical pickup head 420. In this embodiment, the drive module 430 includes, but is not limited to, a focus driver 432, a first moving mechanism 434, a second moving mechanism 436, and a tilt compensator 438. The spherical aberration compensator 440 is coupled to the optical pickup head 420 for performing a spherical aberration compensation upon the optical pickup head 420. The controller module 450 is coupled to the drive module 430 and the spherical aberration compensator 440 for controlling the drive module 430 to perform the predetermined operation during a first period of time and controlling the spherical aberration compensator 440 to perform the spherical aberration compensation during a second period of time, wherein the first period of time overlaps the second period of time.

Please note that the spherical aberration compensator 440 can be implemented by a stepping motor or an LCD (liquid-crystal device), but is not limited to this and can be implemented by other components having the same functionality of spherical aberration compensation. Furthermore, the optical storage apparatus 400 can be a high density DVD player, but should not be a limitation of the present disclosure and can be an optical storage apparatus of other types.

Please refer to FIG. 4 together with FIG. 3. In the following, how each element operates is described by collocating the steps shown in FIG. 3 and the elements shown in FIG. 4.

In the following, descriptions are divided into several cases. In a first case, the predetermined operation is to seek a target track on the optical disc 460 through the first moving mechanism 434. Here, the first moving mechanism 434 is implemented by using a tracking driver. For example, the optical disc 460 has a first information layer (recording layer) L1 and a second information layer (recording layer) L2, and the predetermined operation is to seek a target track TR2 on the second information layer L2 from a current track TR1 on the first information layer L1. In Step 304, therefore, the predetermined operation for seeking the target track TR2 on the optical disc 460 is performed by the first moving mechanism 434 (i.e. the tracking driver) of the drive module 430 during the first period of time T₁₁, and the spherical aberration compensation is performed by the spherical aberration compensator 440 during the second period of time T₂₁, wherein the first period of time T₁₁ overlaps the second period of time T₂₁. The focus jump is then performed by the focus driver 432 (Step 306).

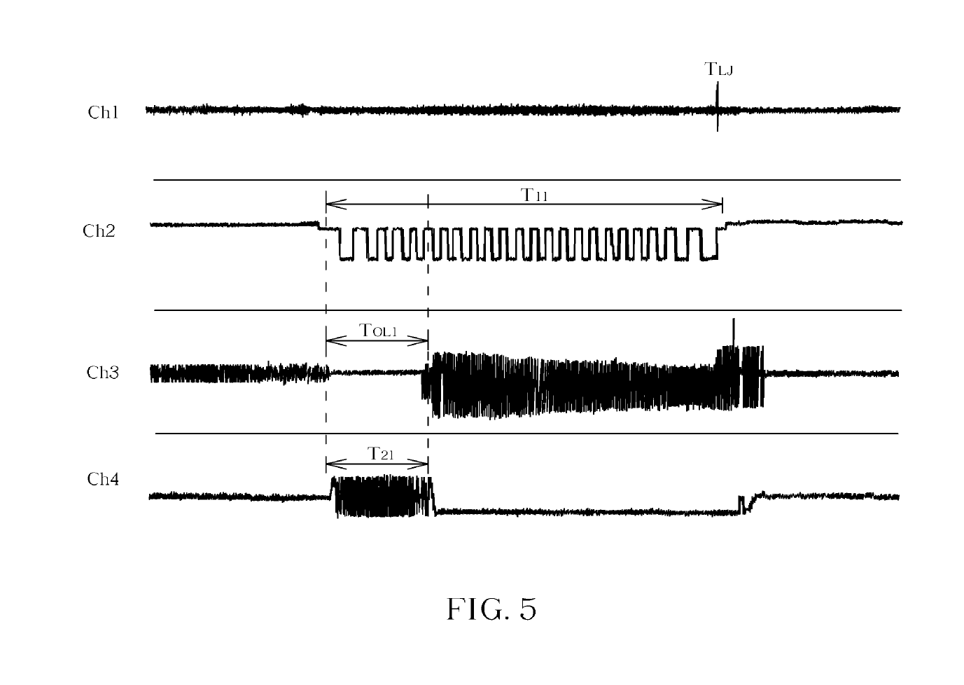

Please refer to FIG. 5. FIG. 5 is a diagram showing waveforms of related signals for accessing an optical disc according to an embodiment of the present disclosure. As shown in FIG. 5, ‘Ch1’ indicates a focus error (FE) signal, ‘Ch2’ indicates a signal for moving a spherical aberration compensator (SAC), ‘Ch3’ indicates a tracking error (TE) signal, and ‘Ch4’ indicates a signal for seeking a target track. A focus jump (layer jump) operation, a spherical aberration compensation, and a track jump (track seek) operation are involved in accessing the optical disc. In this case, the spherical aberration compensation is performed during a second period of time T₂₁, and the trackjump (the predetermined operation for seeking the target track TR2 on the optical disc 460) is performed during the first period of time T₁₁. Assume that T_{OL1} is indicative of the overlay time between the first period of time T₁₁ and the second period of time T₂₁. Therefore, a total time Tₜₒₜₐₗ₁ for accessing the optical disc can be represented by the following equation: Tₜₒₜₐₗ₁=T₁₁+T₂₁+T_{LJ1}−T_{OL1}, whereof the time period T_{LJ1} is used for performing the focus jump and can be ignored due to its value being very small.

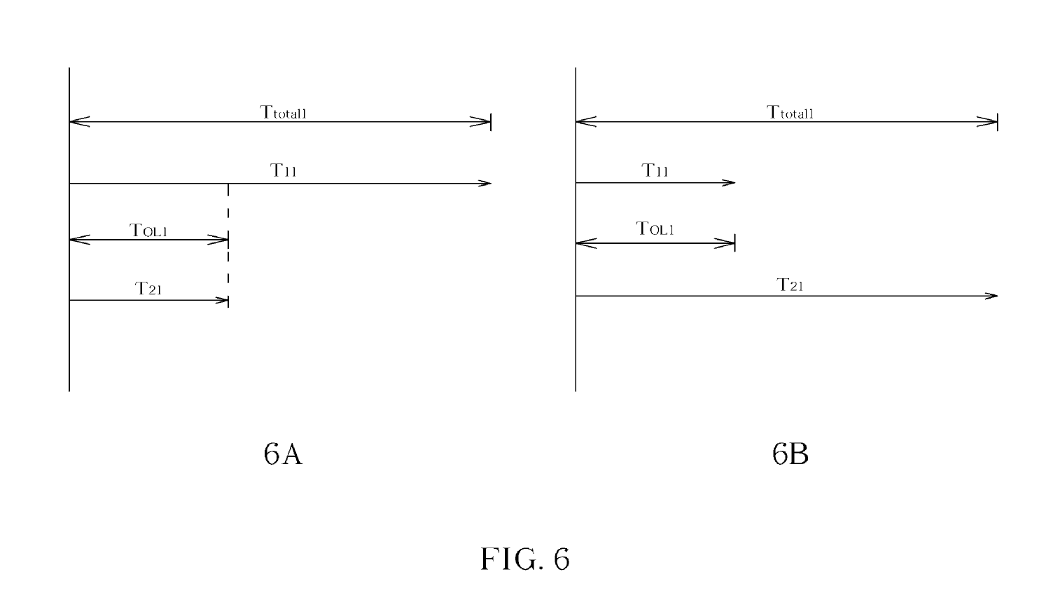

Please note that, if T₂₁<T₁₁ and T_{OL1}=T₂₁, the total time Tₜₒₜₐₗ₁ can be viewed as T₁₁ (please refer to 6A of FIG. 6). If T₁₁<T₂₁ and T_{OL1}=T₁₁, the total time Tₜₒₜₐₗ₁ can be viewed as T₂₁ (please refer to 6B of FIG. 6). The above-mentioned two conditions are conditions of the total time Tₜₒₜₐₗ₁ with optimum performance. Through performing the predetermined operation and performing the spherical aberration compensation during the overlay time T_{OL1}, the total time Tₜₒₜₐₗ₁ for accessing the optical disc can be shortened accordingly. Thereby, the seek performance of the optical storage apparatus 400 can be substantially improved.

In a second case, the predetermined operation is to move a sled on which the optical pickup head 420 is disposed through the second moving mechanism 436. Here, the second moving mechanism 436 is implemented by using a sled driver. In Step 304, the predetermined operation for moving the sled is performed by the second moving mechanism 436 of the drive module 430 during the first period of time T₁₂, and the spherical aberration compensation is performed by the spherical aberration compensator 440 during the second period of time T₂₂, wherein the first period of time T₁₂ overlaps the second period of time T₂₂. The focus jump is then performed by the focus driver 432 (Step 306).

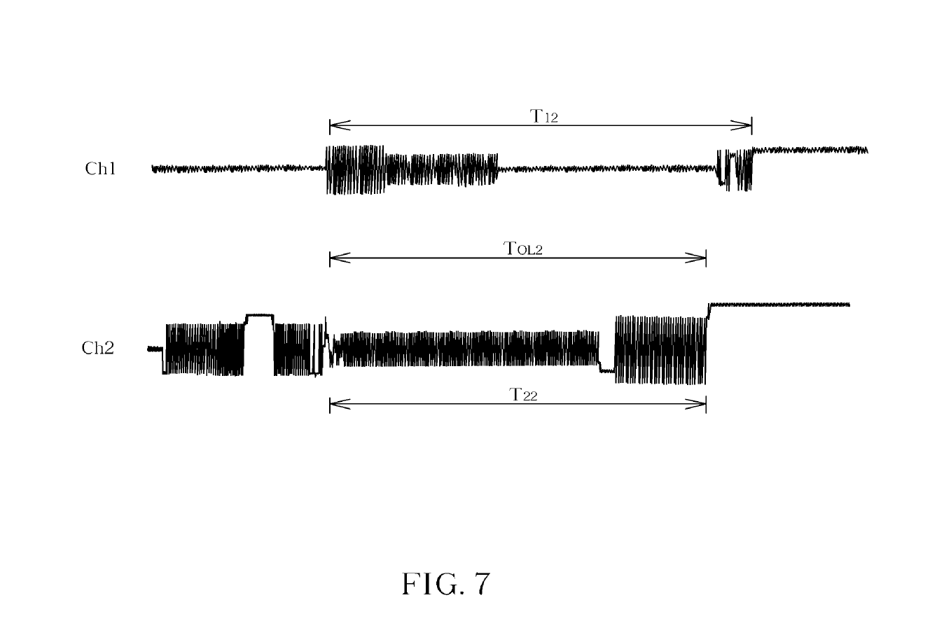

Please refer to FIG. 7. FIG. 7 is a diagram showing waveforms of related signals for accessing an optical disc according to another embodiment of the present disclosure. As shown in FIG. 7, ‘Ch1’ indicates a signal for moving a sled (sled calibration), and ‘Ch2’ indicates a signal for moving a spherical aberration compensator (SAC). In this case, the spherical aberration compensation is performed during the second period of time T₂₂, and the predetermined operation for moving the sled is performed during the first period of time T₁₂. Assume that T_{OL2} is indicative of the overlay time between the first period of time T₁₂ and the second period of time T₂₂. Therefore, a total time Tₜₒₜₐₗ₂ for accessing the optical disc can be represented by the following equation: Tₜₒₜₐₗ₂=T₁₂+T₂₂−T_{OL2}.

In a third case, the predetermined operation is to calibrate a tilt angle between the optical pickup head 420 and the optical disc 460 through the tilt compensator 438. In Step 304, the predetermined operation for calibrating the tilt angle between the optical pickup head 420 and the optical disc 460 is performed by the tilt compensator 438 of the drive module 430 during the first period of time T₁₃, and the spherical aberration compensation is performed by the spherical aberration compensator 440 during the second period of time T₂₃, wherein the first period of time T₁₃ overlaps the second period of time T₂₃. The focus jump is then performed by the focus driver 432 (Step 306). In this case, the spherical aberration compensation is performed during the second period of time T₂₃, and the predetermined operation for calibrating the tilt angle between the optical pickup head 420 and the optical disc 460 is performed during the first period of time T₁₃. Assume that T_{OL3} is indicative of the overlay time between the first period of time T₁₃ and the second period of time T₂₃. Therefore, a total time Tₜₒₜₐₗ₃ for accessing the optical disc can be represented by the following equation: Tₜₒₜₐₗ₃=T₁₃+T₂₃−T_{OL3}.

Please note that the flowchart in FIG. 3 is merely one practical embodiment of the present disclosure, and in no way should be considered to be limitations of the scope of the present disclosure. Moreover, the sequence of the steps in FIG. 3 can be adjusted depending on different situations, and is not limited to the abovementioned sequence. For example, the steps 304 and 306 can be exchanged in the first case. Or the step 306 can be omitted in the second case or in the third case.

The above-mentioned embodiments are presented merely for describing features of the present disclosure, and in no way should be considered to be limitations of the scope of the present disclosure. The above-mentioned optical disc 460 can be a blue-ray disc (BD), a digital versatile disc (DVD), or a high definition DVD (HD DVD), but is not limited to this, and can be a disc of other types. In addition, the optical storage apparatus 400 can be a high density DVD player, but should not be a limitation of the present disclosure and can be an optical storage apparatus of other types. Furthermore, the spherical aberration compensator 440 can be implemented by a stepping motor or an liquid-crystal device (LCD), but is not limited to this and can be implemented by other components. Please note that the flowchart in FIG. 3 is presented merely a practical embodiment of the present disclosure, and in no way should be considered to be limitations of the scope of the present disclosure. Moreover, the sequence of the steps in FIG. 3 can be adjusted depending on different situations, and is not limited to the abovementioned sequence. In one embodiment, the predetermined operation is to seek a target track on the optical disc. In another embodiment, the predetermined operation can be to move a sled or to calibrate a tilt angle, but they are merely embodiments for illustrating the spirit of the present disclosure. Those skilled in the art should appreciate that various modifications of the predetermined operation may be made without departing from the spirit of the present disclosure.

In summary, the present disclosure provides an optical storage apparatus for accessing an optical disc and a method thereof. The spirit of the present disclosure is to perform the predetermined operation during the first period of time and to perform the spherical aberration compensation during the second period of time, wherein the first period of time overlaps the second period of time. Because performing the spherical aberration compensation usually wastes a lot of time, the total time Tₜₒₜₐₗ₁ for accessing the optical disc will be prolonged. Therefore, by performing the predetermined operation and performing the spherical aberration compensation during the overlay time T_{OL1}, the total time Tₜₒₜₐₗ₁ for accessing the optical disc can be shortened. Thereby, the seek performance of the optical storage apparatus 400 can be improved greatly. Besides, the spherical aberration compensation and a compensation for moving a sled are needed when powering on an optical storage apparatus (i.e. the second case), which also wastes a lot of time and affects the seek performance of the whole system. Hence, the present disclosure is not limited to be applied to performing the spherical aberration compensation together with a sled compensation or a track jump only, and can be expanded to be applied to other applications without departing from the spirit of the present disclosure.

Those skilled in the art will readily observe that numerous modifications and alterations of the device and method may be made while retaining the teachings of the disclosure.

What is claimed is:

1. An optical storage apparatus for accessing an optical disc, the optical storage apparatus comprising:
an optical pickup head, for generating a light spot onto the optical disc;
a drive module, coupled to the optical pickup head, for performing a predetermined operation associated with the optical pickup head;
a spherical aberration compensator, coupled to the optical pickup head, for performing a spherical aberration compensation upon the optical pickup head; and
a controller module, coupled to the drive module and the spherical aberration compensator, for controlling the drive module to perform the predetermined operation during a first period of time and the spherical aberration compensator to perform the spherical aberration compensation during a second period of time, wherein the first period of time overlaps the second period of time.

2. The optical storage apparatus of claim 1, wherein the drive module comprises a moving mechanism, and the controller module controls the moving mechanism to perform the predetermined operation for seeking a target track on the optical disc.

3. The optical storage apparatus of claim 2, wherein the optical disc has a first information layer and a second information layer, and the predetermined operation is to seek the target track on the second information layer from a current track on the first information layer.

4. The optical storage apparatus of claim 1, wherein the drive module comprises a moving mechanism, and the controller module controls the moving mechanism to perform the predetermined operation for moving a sled on which the optical pickup head is disposed.

5. The optical storage apparatus of claim 1, wherein the drive module comprises a tilt compensator, and the controller module controls the tilt compensator to perform the predetermined operation for calibrating a tilt angle between the optical pickup head and the optical disc.

6. A control chip for controlling an optical pickup head to access an optical disc, the control chip comprising:
a drive module, for performing a predetermined operation associated with the optical pickup head;
a spherical aberration compensator, for performing a spherical aberration compensation upon the optical pickup head; and
a controller module, coupled to the drive module and the spherical aberration compensator, for controlling the drive module to perform the predetermined operation during a first period of time and the spherical aberration compensator to perform the spherical aberration compensation during a second period of time, wherein the first period of time overlaps the second period of time.

7. The control chip of claim 6, wherein the drive module comprises a moving mechanism, and the controller module controls the moving mechanism to perform the predetermined operation for seeking a target track on the optical disc.

8. The control chip of claim 7, wherein the optical disc has a first information layer and a second information layer, and the predetermined operation is to seek the target track on the second information layer from a current track on the first information layer.

9. The control chip of claim 6, wherein the drive module comprises a moving mechanism, and the controller module controls the moving mechanism to perform the predetermined operation for moving a sled on which the optical pickup head is disposed.

10. The control chip of claim 6, wherein the drive module comprises a tilt compensator, and the controller module controls the tilt compensator to perform the predetermined operation for calibrating a tilt angle between the optical pickup head and the optical disc.

11. An optical storage apparatus for accessing an optical disc, the optical storage apparatus comprising:
an optical pickup head, for generating a light spot onto the optical disc;
a drive module, coupled to the optical pickup head, for performing a predetermined operation associated with the optical pickup head;
a compensator, coupled to the optical pickup head, for performing a compensation upon an optical characteristic of the optical pickup head; and
a controller module, coupled to the drive module and the compensator, for controlling the drive module to perform the predetermined operation during a first period of time and the compensator to perform the compensation upon an optical characteristic of the optical pickup head during a second period of time, wherein the first period of time overlaps the second period of time.

12. The optical storage apparatus of claim 11, wherein the drive module comprises a moving mechanism, and the controller module controls the moving mechanism to perform the predetermined operation for seeking a target track on the optical disc.

13. The optical storage apparatus of claim 12, wherein the optical disc has a first information layer and a second information layer, and the predetermined operation is to seek the target track on the second information layer from a current track on the first information layer.

14. The optical storage apparatus of claim 11, wherein the drive module comprises a moving mechanism, and the controller module controls the moving mechanism to perform the predetermined operation for moving a sled on which the optical pickup head is disposed.

15. The optical storage apparatus of claim 11, wherein the drive module comprises a tilt compensator, and the controller module controls the tilt compensator to perform the predetermined operation for calibrating a tilt angle between the optical pickup head and the optical disc.

16. A method of driving an optical pickup head utilized for accessing an optical disc, the method comprising:
performing a predetermined operation upon an optical pickup head during a first period of time; and
performing a spherical aberration compensation upon the optical pickup head during a second period of time, wherein the first period of time overlaps the second period of time.

17. The method of claim 16, wherein the predetermined operation is to seek a target track on the optical disc.

18. The method of claim 17, wherein the optical disc has a first information layer and a second information layer, and the predetermined operation is to seek the target track on the second information layer from a current track on the first information layer.

19. The method of claim 16, wherein the predetermined operation is to move a sled on which the optical pickup head is disposed.

20. The method of claim 16, wherein the predetermined operation is to calibrate a tilt angle between the optical pickup head and the optical disc.
